(19) United States
(12) Patent Application Publication
(10) Pub. No.: US 2021/0101337 A1
(43) Pub. Date: Apr. 8, 2021

(54) End Effector

(71) Applicant: Advanced Solutions Life Sciences, LLC, Louisville, KY (US)

(72) Inventors: Scott Douglas Cambron, Louisville, KY (US); Justin Palmer, Louisville, KY (US)

(73) Assignee: Advanced Solutions Life Sciences, LLC, Louisville, KY (US)

(21) Appl. No.: 17/061,625

(22) Filed: Oct. 2, 2020

Related U.S. Application Data
(60) Provisional application No. 62/909,467, filed on Oct. 2, 2019.

(51) Int. Cl. B29C 64/209; B33Y 30/00

(52) U.S. Cl. CPC B29C 64/209; B33Y 30/00

(57) ABSTRACT

An end effector includes a continuous volume that holds a constituent and includes a nozzle, a suspension frame disposed within the continuous volume, an actuator, and an agitation needle that protrudes from the continuous volume through the nozzle. The actuator is suspended by the suspension frame within the continuous volume such that the constituent within the continuous volume is in direct contact with one or more of the actuator and the agitation needle. The actuator is configured to actuate such that, upon actuation, the constituent transforms from a static state to a pseudo-fluid like state for application with the end effector.

### CROSS-REFERENCE TO RELATED APPLICATIONS

This application claims the benefit of U.S. Provisional Application Ser. No. 62/909,467, filed Oct. 2, 2019, and entitled End Effector for Accurately and Repeatedly Dispensing Powder/Granules, the entirety of which is incorporated by reference herein.

### TECHNICAL FIELD

The present specification generally relates to three-dimensional (“3D”) printers and, more specifically, to end effectors for dispensing constituent in 3D printers.

### BACKGROUND

3D printers may deposit a constituent material to form a construct. In its base form, the constituent material may be, for example, a solid in powder or granule form. Additionally, particular types of 3D constructs or 3D printing applications may require precise dispensing of constituent and therefore exacting measurement of the mass or volume of constituent dispensed through an end effector or otherwise to form a construct. For example, such exacting measurement may be required when generating pharmacological constructs. Accordingly, an end effector for accurately and repeatedly dispensing powder or granules may be required.

### SUMMARY

In one embodiment, an end effector includes a continuous volume that holds a constituent and includes a nozzle, a suspension frame disposed within the continuous volume, an actuator, and an agitation needle that protrudes from the continuous volume through the nozzle. The actuator is suspended by the suspension frame within the continuous volume such that the constituent within the continuous volume is in direct contact with one or more of the actuator and the agitation needle. The actuator is configured to actuate such that, upon actuation, the constituent transforms from a static state to a pseudo-fluid like state for application with the end effector.

In another embodiment, an end effector includes a continuous volume that holds a constituent and includes a nozzle, a suspension frame disposed outside the continuous volume, an actuator, and an agitation needle that protrudes from the continuous volume through the nozzle. The actuator is suspended by the suspension frame outside the continuous volume and coupled to the agitation needle. The actuator is configured to actuate such that, upon actuation, the constituent transforms from a static state to a pseudo-fluid like state for application with the end effector.

In yet another embodiment, a 3D printer toolbody includes a mount including an arm mount portion, and a tool mount portion, and an end effector including a continuous volume including a nozzle and configured to hold a constituent, a suspension frame disposed within the continuous volume, an actuator, and an agitation needle that protrudes from the continuous volume through the nozzle. The actuator is suspended by the suspension frame within the continuous volume such that the constituent within the continuous volume is in direct contact with one or more of the actuator and the agitation needle, and the actuator is configured to actuate such that, upon actuation, the constituent transforms from a static state to a pseudo-fluid like state for application with the end effector. The end effector is coupled to the tool mount portion of the mount and the arm mount portion is coupled to a robotic arm of a 3D printer configured to move the 3D printer toolbody to form a 3D printed construct.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an exploded view of an end effector for dispensing powder or granules via vibratory action, according to one or more embodiments shown and described herein;

FIG. 2 depicts a second view of the end effector of FIG. 1, according to one or more embodiments shown and described herein;

FIG. 3A depicts an actuator and frame assembly of the end effector depicted in FIG. 1, according to one or more embodiments shown and described herein;

FIG. 3B depicts a particular embodiment of an agitation effector, according to one or more embodiments shown and described herein;

FIG. 3C depicts another particular embodiment of an agitation effector, according to one or more embodiments shown and described herein;

FIG. 4 depicts the end effector of FIG. 1 coupled to a 3D printer toolbody, according to one or more embodiments shown and described herein;

FIG. 5 depicts a prototype embodiment of an end effector similar to the end effector of FIG. 1 including an agitation effector, according to one or more embodiments shown and described herein;

FIG. 6 depicts a prototype embodiment of an end effector including an actuator that is disposed externally to a material barrel of the end effector, according to one or more embodiments shown and described herein;

FIG. 7 depicts an end effector including multiple externally-disposed actuators, according to one or more embodiments shown and described herein;

FIG. 8A depicts the end effector of FIG. 7 including multiple externally-disposed actuators, according to one or more embodiments shown and described herein;

FIG. 8B depicts an agitation needle assembly including an agitation effector of the end effector of FIG. 7, according to one or more embodiments shown and described herein;

FIG. 9A depicts the end effector of FIG. 7 and a mount for mounting the end effector, according to one or more embodiments shown and described herein; and

FIG. 9B depicts the end effector and mount of FIG. 9A in an operational arrangement, according to one or more embodiments shown and described herein.

### DETAILED DESCRIPTION

Embodiments as disclosed herein are directed to an end effector for consistently dispensing constituent from a 3D printing tool to print a 3D construct. The end effector generally includes a material barrel for holding a constituent in a static or packed form (e.g., a granular material such as a powder or granules), an actuator and frame assembly for holding an actuator that is capable of transforming the constituent into a depositable form (i.e., in a fluid granular state) suitable for dispensing by the end effector of the 3D printer. The end effector generally includes a nozzle and a wire that protrudes from the nozzle. In the depositable form, constituent travels along the wire and out the nozzle where it is deposited on the printing stage of the 3D printer, thus forming the construct.

A granular material is a complex system which may exhibit non-trivial transitions between static, quasi-static, and dynamic states based on external factors such as, for example, mechanical excitation or gravity. That is, granular materials can behave like a solid or a fluid according to applied stress. As an example, when a collection of grains forms a pile in a container, the material can be roughly compared to a solid and the material can be described as in the static state. However, if the container is sufficiently tilted, the granular material may move or flow within the container and can be described as in the dynamic state. In the dynamic state, surface layers of the grains may behave similarly to a liquid moving dynamically throughout the container. Between the static and the dynamic states, a granular assembly can experience a quasi-static state.

Constituents used in the end effectors described herein generally have a powder or granule form prior to actuation of the end effector. That is, between discrete particles, the level of cohesiveness or localized friction is sufficient to maintain the powder or granules in the static state. Upon sufficient actuation (e.g., mechanical vibration causing inter-particle acceleration), the cohesiveness or localized friction between particles is reduced and the powder or granules may transform from a solid state to a pseudo fluid state. When the vibrational characteristics of actuators and other components capable of imparting mechanical forces on the particles are optimized for the powder or granule, the powder or granule transforms to the depositable state and constituent can flow through and out the end effector.

Additionally, the physical position of the end effector with respect to the print stage may be controlled, for example, by a multi-axis robotic arm that may be moveable via instructions provided to a controller of the multi-axis robotic arm via a multi-purpose computer communicatively coupled to a user interface. Accordingly, 3D-printed constructs having various sizes and shapes may be formed using the end effector. These and additional features will be described in greater detail herein.

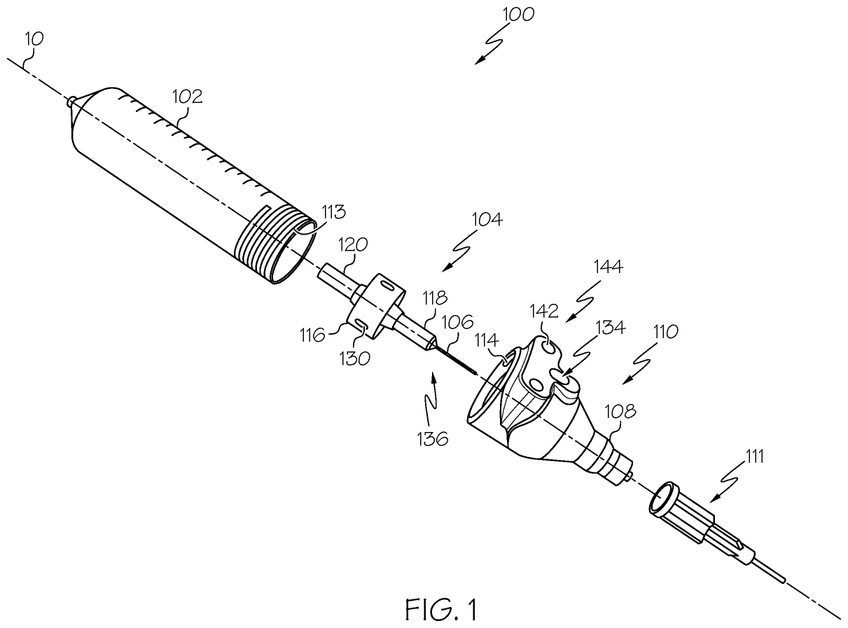

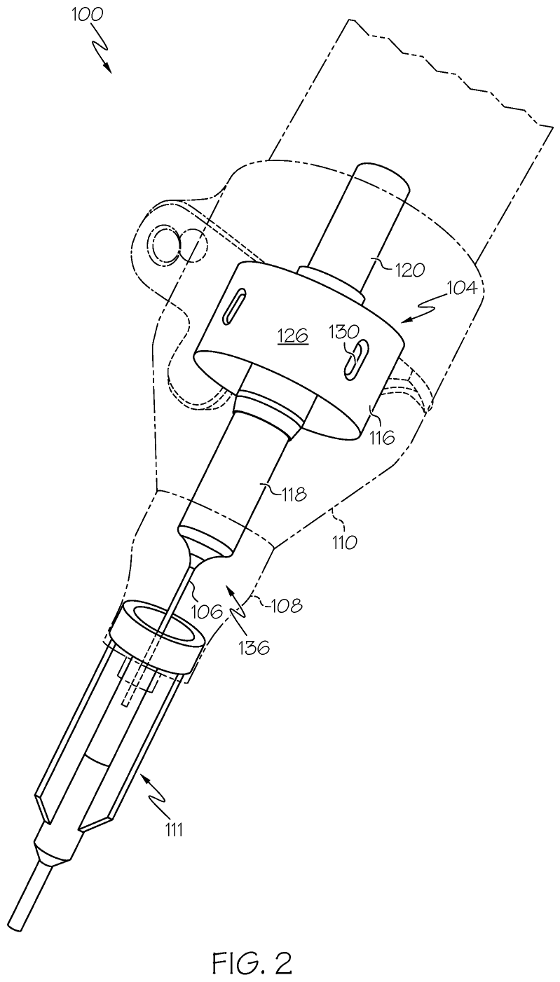

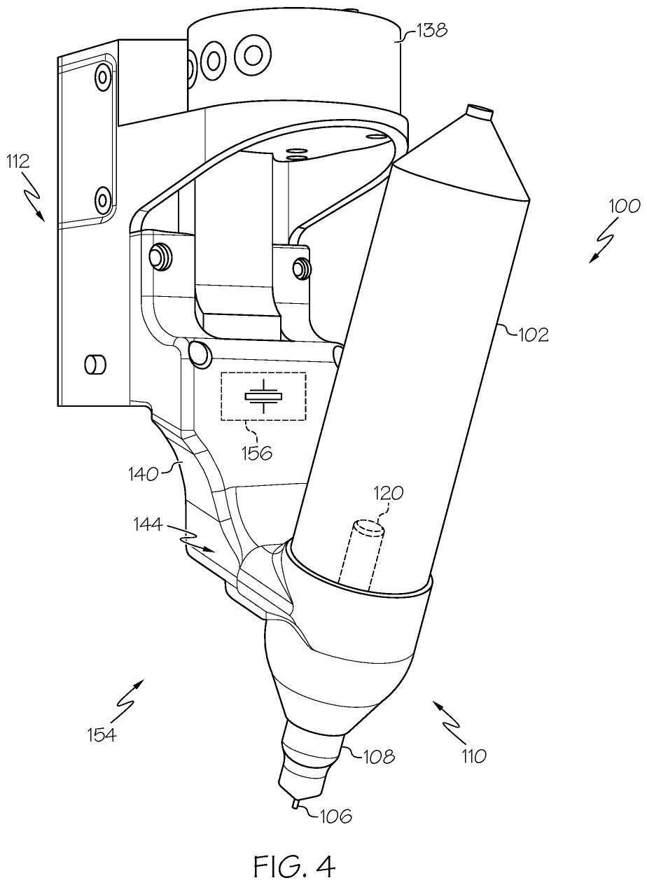

FIGS. 1 and 2 generally depict an end effector 100. The end effector 100 may include a material barrel 102, an actuator and frame assembly 104, an agitation needle 106, and a funnel housing 110 that includes a nozzle 108. Embodiments of the end effector 100 may also include a dispense tip 111. The end effector 100 and its components may generally extend in a longitudinal direction along a longitudinal axis 10. Briefly referring to FIG. 4, the end effector 100 may be coupled to a mount 112 and may be used to apply a constituent to build a 3D-printed construct (“construct”) in a 3D printer. The constituent may flow through the end effector 100 and be transformed from a solid constituent to a pseudo fluid state via the motion of actuators of the frame assembly 104. In the pseudo fluid state, the constituent may flow through the nozzle 108 to be applied by the mount 112 to form a construct as will be described in greater detail herein. More specifically, the constituent may transform from a static packed/coherent state into a pseudo-fluid like state, mimicking flow of liquid during dispense.

Referring again to FIGS. 1 and 2, the material barrel 102, the actuator and frame assembly 104, the funnel housing 110, and the nozzle 108 may be physically coupled such that the interior chambers and voids of the respective components form a continuous volume. In some embodiments, the material barrel 102 may be, for example, a commercially-available, generally-longitudinal fifty mL vial or a centrifuge vial. However, other shapes and sizes of material barrel are contemplated. In some embodiments, the material barrel 102 or other portion of the continuous volume may be fluidly coupled to a pressure source to apply pressure to the continuous volume in order to assist constituent through the nozzle during 3D printing. In some embodiments, a mechanical actuator (e.g., a linear actuator, plunger, etc.) may be coupled to the material barrel 102 to assist constituent to flow through the end effector 100. Some embodiments may use gravity or a combination of pressure sources and/or gravity. In some embodiments, the material barrel 102 may depict volumetric gradations to show the volumetric flow of the constituent through the end effector 100.

The funnel housing 110 may include the nozzle 108, which may include one or more orifices (not pictured) at a distal end of the end effector 100 through which constituent may flow in the fluid-like state. Additionally, the funnel housing 110 includes bolt locations 142 and a wiring cavity 134 at an attachment interface 144. The funnel housing 110 may be configured to receive the dispense tip 111 at an interface, such as a threaded connection between the funnel housing 110 and the dispense tip 111. The dispense tip 111 may be, for example, a disposable probe or needle designed for use with dispensing machines and/or syringes.

The end effector 100 may couple to one or more other components at the attachment interface 144 as will be described in greater detail herein. In some embodiments, the nozzle 108 and the funnel housing 110 may be distinct components and may share, for example, a press fit or threaded connection. In yet other embodiments, the nozzle 108 and the funnel housing 110 are formed as a continuous, solid component. As shown in FIG. 2, the funnel housing 110 may include internal structure (e.g., internal walls or surfaces) that provide support to the actuator and frame assembly 104 and that direct the flow of constituent as it transforms from the solid state to the fluid-like state for dispensation. Accordingly, the actuator and frame assembly 104 can be housed within the continuous volume formed by the internal cavities of the end effector 100 allowing actuating mechanisms of the actuator and frame assembly 104 to be in direct contact with the constituent.

Referring to FIG. 1, the material barrel 102 may include a threaded ending such as the threaded fitting 113, for example, which may thread into a threaded fitting 114 of the funnel housing 110. However, it is contemplated that the material barrel 102 may be coupled to one or more other components of the end effector 100 via other means. For example, the material barrel 102 may be press fit within the funnel housing 110 or the funnel housing 110 may be press fit within the material barrel 102. Embodiments in which the material barrel 102 and the funnel housing 110 form a continuous component are also contemplated. The actuator and frame assembly 104 may be coupled to one or more components of the end effector 100 as will be described in greater detail below.

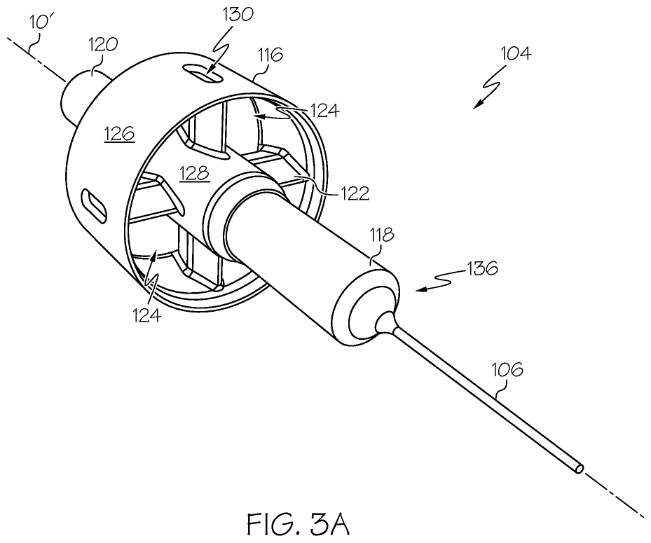

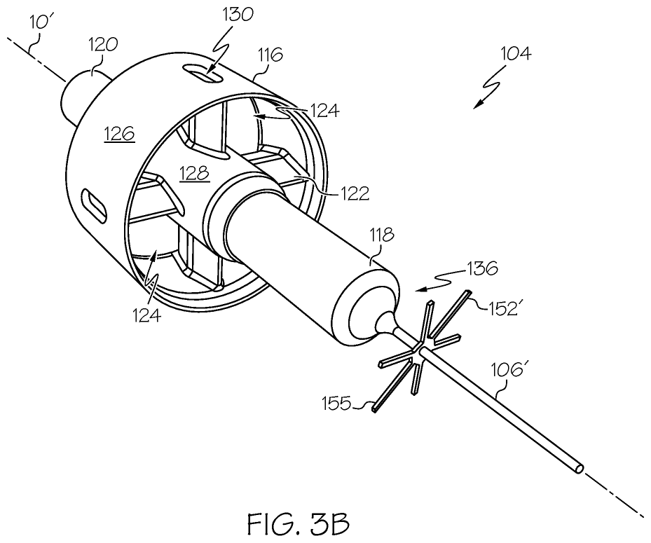

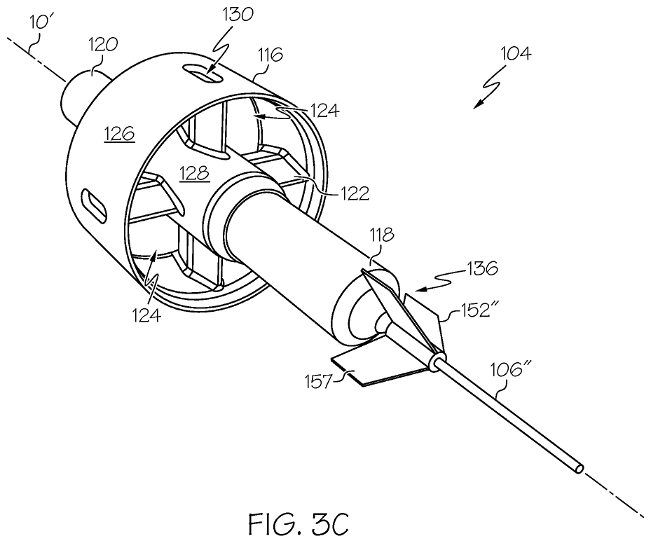

Referring to FIG. 3A, the actuator and frame assembly 104 may include a suspension frame 116 and one or more actuators that include an actuating surface. As depicted in FIG. 3A, the actuator and frame assembly 104 includes a first motor 118 and a second motor 120, but it is contemplated that the actuator may be any number of devices for imparting sufficient kinetic energy to the constituent to transform it from a solid to a pseudo fluid state. In some embodiments, the agitation needle 106 may be coupled to the actuator and frame assembly 104. For example, as shown in FIG. 3A, the agitation needle 106 may be coupled directly to a distal end of the first motor 118. However, embodiments in which the agitation needle 106 is coupled to a different portion of the actuator and frame assembly 104 are contemplated. In embodiments, the agitation needle 106 may couple to the actuator at a needle-actuator interface 136 and the agitation needle 106 may be interchangeable such that agitation needles of various diameters or longitudinal profiles may be coupled to the actuator. For example, the agitation needle 106 may be of any diameter such that there is sufficient clearance between the agitation needle 106 and internal surfaces of the nozzle 108 (FIGS. 1 and 2) such that constituent can flow along the agitation needle 106 and out the nozzle 108 as described in greater detail herein. Briefly referring to FIGS. 3B and 3C, in some embodiments, the agitation needle 106 may include one or more agitation effectors 152 for promoting sufficient flow of constituent. The agitation effector 152 may, for example, be tuned to inhibit clogging within the nozzle 108. The characteristics (e.g., size, shape, etc.) of the agitation needle 106 and/or agitation effector 152 may depend on the particular characteristics of the constituent and the construct being printed. For example, FIG. 3B shows an agitation effector 152′ having six prongs extending from a central axis and FIG. 3C shows an agitation effector 152″ having three fins extending from a central axis in parallel with the agitation needle 106.

Referring to FIGS. 2 and 3A, the one or more actuators may be, for example, vibratory motors. For example, the first motor 118 and the second motor 120 may be vibratory motors. The first motor 118 and the second motor 120 may include an electric motor with an eccentric or unbalanced mass on a drive shaft capable of producing sufficient eccentric motion to generate vibrations that transform the constituent form a solid state to a pseudo fluid state. It is contemplated that the actuator may be any type of actuator capable of imparting sufficient energy to the constituent. For example, the actuator may include one or more ultrasonic transducers. The amplitude and frequency of actuation may vary based on one or more factors, such as the chemical properties of the constituent or parameters of the intended construct. For example, in embodiments in which the actuator includes one or more vibratory motors, the vibratory motors may operate at a frequency between 1,000 and 16,000 rpm. In other embodiments, the vibratory motors may operate at a frequency between 4,000 and 12,000 rpm. In yet other embodiments, the vibratory motors may operate at a frequency between 6,000 and 10,000 rpm. In yet other embodiments, the vibratory motors may operate at a frequency between 1 and 20,000 RPM.

Referring to FIG. 3A, the suspension frame 116 may include one or more fins 122 that form one or more channels 124. The fins 122 may extend radially from a longitudinal axis 10′ of the actuator and frame assembly 104 between an outer wall 126 and an inner wall 128 of the suspension frame 116. The fins 122 may provide structural support to the motors of the end effector 100 as well as form the channels 124 that provide a channel constituent in solid form (e.g., powder, granules, etc.) to flow through the continuous volume formed by the end effector 100 such that the constituent is in contact with actuating surfaces of the actuator (e.g., the exterior surfaces of the first motor 118 and the exterior surfaces of the second motor 120). While the depicted embodiment includes a suspension frame 116 with four fins 122 that have a generally planar shape along the longitudinal axis 10′, it is contemplated that embodiments may include any different number and shape of fins 122 such that sufficient rigidity is provided to the various components of the end effector 100 (not depicted in FIG. 3A) and support is provided to the actuator to keep it suspended within the end effector 100. The suspension frame 116 may be rigidly coupled to the funnel housing 110 via a press fit between the outer wall 126 of the suspension frame 116 and the funnel housing 110 such that the first motor 118, the second motor 120, and the agitation needle 106 are suspended within the end effector 100, thereby allowing continuous flow of constituent along the first motor 118, the second motor 120, and the agitation needle 106.

Still referring to FIG. 3A, the actuator and frame assembly 104 may further include one or more ports 130. The ports 130 may provide space for the passage of wires (not depicted) or other aspects of the end effector 100 and generally open to a hollow chamber or chambers within the fins 122 (not depicted). Wires may be used, for example, to provide electrical power to the first motor 118 and second motor 120. As depicted in FIG. 3A, each fin 122 includes a port 130 and at least one chamber within the fin 122 (not depicted), however it is contemplated that various embodiments may include more or fewer ports and chambers (not depicted) and that the ports 130 may be differently arranged. For example, a particular fin 122 may include two or more ports or no ports. Briefly referring to FIGS. 1 and 3A, the funnel housing 110 may include the wiring cavity 134 which may provide a cavity for running wires from an external power and/or control source (not depicted) through the funnel housing 110, through the ports 130, into the chambers (not depicted) in the fins 122 and to the actuators (e.g., the first motor 118 and the second motor 120). In some embodiments, the ports 130 and/or the wiring cavity 134 may include a seal (not pictured) or other means for preventing the release of constituent through the ports 130 and/or the wiring cavity 134 or the entry of external material into the system via the same.

Still referring to FIG. 3A, the agitation needle 106 may be coupled to the actuator and frame assembly 104 at the needle-actuator interface 136. As depicted, the agitation needle 106 is coupled to the first motor 118, but embodiments in which the agitation needle 106 is coupled to some other portion of the actuator and frame assembly 104 or, more generally, the end effector 100 are contemplated. For example, the agitation needle 106 may be coupled to the second motor 120 or at a distal end (not shown) of the inner wall 128 along the longitudinal axis 10′ or at another location on the end effector 100. The agitation needle 106 may be welded, brazed, or otherwise permanently coupled to the actuator. In some embodiments, various sizes and shapes of agitation needle 106 may be interchangeable with a particular suspension frame 116 allowing quick interchange of agitation needle 106 based on, for example, the characteristics of the constituent used in the 3D printer (e.g., molecular size/shape, flow characteristics, etc.).

FIGS. 3B and 3C generally depict agitation needles including various embodiments of agitation effectors. FIG. 3B depicts an agitation needle 106′ that includes the agitation effector 152′. The agitation effector 152′ includes multiple tongs 155 that may agitate constituent as it passes through the assembly and along the agitation needle 106. FIG. 3C depicts an agitation needle 106″ that includes the agitation effector 152″ that includes multiple fins 157 that may agitate constituent as it passes through the assembly and along the agitation needle 106″. Various embodiments of the end effector 100 may include different types of agitation effectors and embodiments are not limited by the particular features shown in the drawings and described. Particular aspects (e.g., dimensions, material, number of subcomponents) of an agitation effector may be tuned to the various materials that are to be deposited by the end effector as is described in greater detail herein.

Generally referring to FIGS. 1, 2, and 3A, constituent may be placed within the material barrel 102 and the material barrel 102 may be fastened to the funnel housing 110 to form a continuous volume surrounding the constituent and the one or more actuators. As constituent flows through the continuous volume along the external surfaces of the internal components of the end effector 100, it may flow through the channels 124 and along the agitation needle 106 out the end effector 100 for application. The position of the end effector 100 may be moved by a robotic arm, for example, such that detailed constructs may be printed as is described herein.

Referring now to FIG. 4, a mount 112 for coupling the end effector 100 to a robotic arm (not pictured) of a 3D printer is depicted. Taken together, the mount 112 and the end effector 100 may form a 3D printer toolbody 154 that may be used to form a 3D-printed construct. The mount 112 may include any structure configured for engaging the end effector 100 to the robotic arm, such that the robotic arm can manipulate a position of the end effector 100. For example, the mount 112 may include an arm mount portion 138 configured to be mounted to the robotic arm through one or more pins, fasteners, magnets, or the like. In some embodiments, the arm mount portion 138 may include a pneumatic connection which may be released via a button, for example. Coupled to the arm mount portion 138 may be a tool mount portion 140 to which the end effector 100 may be coupled. For example, referring to FIGS. 1 and 4, the end effector 100 may include an attachment interface 144 that removably couples the end effector 100 to the tool mount portion 140 and, thus, to the arm mount portion 138.

As shown in FIG. 1, the attachment interface 144 may include a connection means for connecting the end effector 100 to the tool mount portion 140. For example, bolts (not shown) may be used to secure the end effector 100 to the tool mount portion 140 at bolt locations 142 on the funnel housing 110. Other embodiments may include various connection means. For example, connections may utilize clamps, ties, quick releases, etc. Thus, the attachment interface 144 provides for modular connection of various end effectors similar to the end effector 100 for expedient adaptable removal of an end effector, thereby making the tool mount portion 140 and/or the arm mount portion 138 usable with multiple end effectors. Additionally, the removable connections may improve serviceability or adaptability of the 3D printer as various end effectors may be removed and replaced for cleaning, quickly changing constituent types, etc.

Briefly referring to FIGS. 1 and 4, as the constituent is deposited onto the print stage using the end effector 100, the weight of the end effector 100 decreases. In some embodiments, one or more components of the end effector 100 or the 3D printer toolbody 154 may include a measurement transducer (e.g., a strain gage, a load cell, a piezoelectric sensor, etc.), such as the measurement transducer 156 schematically depicted in FIG. 4 to measure the amount of constituent that is deposited using the end effector 100. The amount of constituent deposited may be measured, for example, by comparing a weight of the end effector 100 empty and full of constituent and continuously measuring the weight as the constituent is deposited to form the construct. In some embodiments, a known weight of an empty end effector 100 may be used. In other embodiments, a 3D printing system may include a print stage that includes a scale or other measurement device that can measure the amount of constituent deposited on the print stage, thereby determining an amount of constituent having left the material barrel 102.

Referring now to FIGS. 1-4, operation of the end effector 100 to form a 3D-printed construct will be described. Constituent may be placed in a material barrel 102 and the material barrel 102 may be joined to the nozzle 108 and/or the funnel housing 110 via, for example, the threaded fitting 113 of the material barrel 102 and the threaded fitting 114 of the funnel housing 110. Additionally, the end effector 100 may be removably coupled to the mount 112 at the attachment interface 144 and the mount 112 may be moved with a robotic arm or other mechanism of a 3D printer, such as the robotic arm described in U.S. patent application Ser. No. 16/906,391, which is hereby incorporated by reference in its entirety. Thus, the 3D printer may control the motion of the end effector 100 to apply constituent during printing onto a print stage based on instructions or plans for printing a construct uploaded by a user.

With the robotic arm (not shown) controlling the location of the end effector 100 and thus the tip of the agitation needle 106, the 3D printer may cause electrical power to be applied to the actuator, actuating it. Upon actuation, the first motor 118 and the second motor 120 may vibrate at a frequency sufficient to transform the constituent within the material barrel 102 from a static or solid state to a fluid-like state. In the depicted embodiment, the vibration of the first motor 118 and the second motor 120 also causes the agitation needle 106 to vibrate. Because the constituent is in contact with the first motor 118, the second motor 120, and the agitation needle 106 and thus subjected to the vibration of the motors. The vibration causes the constituent to transform from a solid or static state to a pseudo fluid state. Once in the pseudo fluid state the constituent flows along the outer surfaces of the motors and the agitation needle 106. The constituent flows through the nozzle 108 and is deposited by the end effector 100 to form a construct on the print stage (not shown) of the 3D printer.

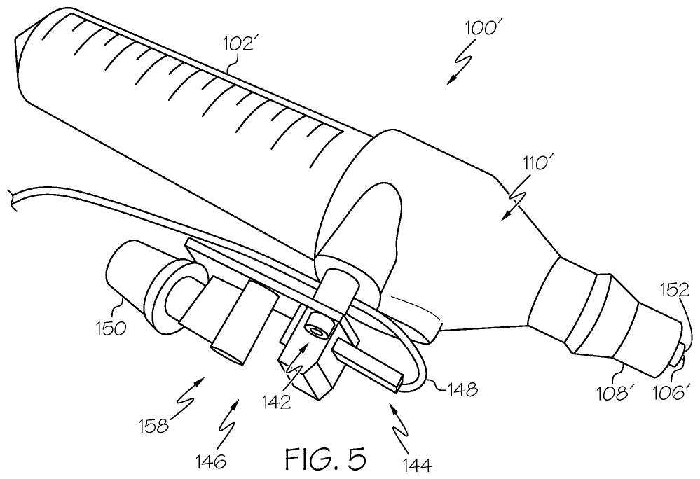

Referring now to FIG. 5, an end effector 100′ is shown. The embodiment depicted in FIG. 5 may be, for example, a hand-held prototype of the internally agitated embodiments described above. FIG. 5 shows a printed circuit board (PCB) 158 that is attached to the end effector 100′. In some embodiments, the components of the PCB 158 may be integrated into the end effector 100′, for example, may be housed in the nozzle 108′. The end effector 100′ includes the material barrel 102′, the actuator and frame assembly (not shown) inside the nozzle 108′, the funnel housing 110′, and the agitation needle 106′. The actuator and frame assembly includes two motors such as the first motor 118 and the second motor 120 depicted in FIGS. 1-3A. Mounted to the nozzle 108′ is a controller 146 that is electrically coupled to a power source (not shown) via wires 148. The controller 146 may provide electrical power to the one or more motors and may include one or more controls for adjusting a frequency or an amplitude of the vibrations such as a knob 150. In other embodiments of the system, the frequency and/or amplitude may be controlled by software control, for example. In some embodiments, the end effector 100 may be battery powered such that embodiments may not include the wires 148.

As shown in FIG. 5 and discussed above with respect to FIGS. 3A and 3B, the agitation needle 106′ may include one or more features for agitating constituent within the nozzle 108′, such as the agitation effector 152. The agitation effector 152 may have any shape or profile suitable for assisting the flow of constituent through the nozzle 108′ and onto the print stage (not shown). The agitation needle 106′ and/or agitation effector 152 may be removable or replaceable. In some embodiments, one or more of the agitation needle 106′ and the agitation effector 152 may be modular and various shapes and profiles of agitation needles 106′ and agitation effectors 152 may be swapped in and out to operate with the end effector 100′.

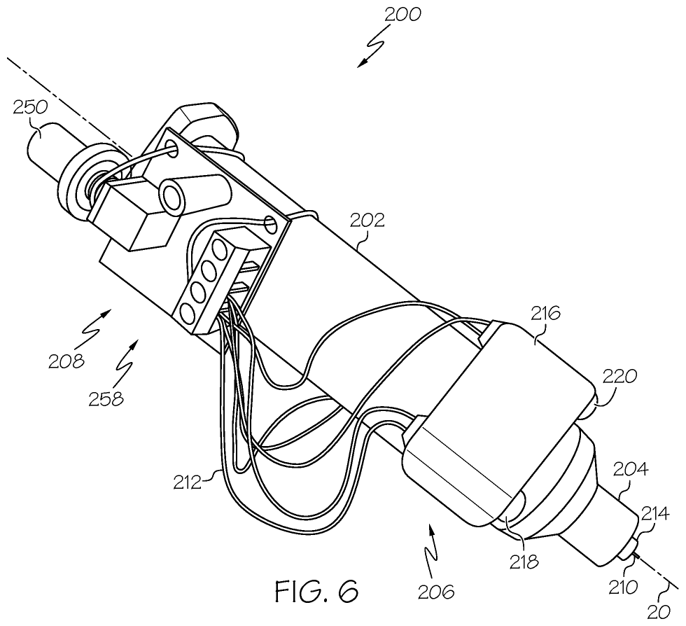

Referring now to FIG. 6, an end effector 200 that includes an external actuation source is shown. The embodiment depicted in FIG. 6 may be a hand-held prototype, for example, of the externally agitated embodiments described below. The end effector 200 may include a PCB 258 that is attached to the end effector 200. In some embodiments, one or more of the components of the PCB 258 may be integrated into the end effector 200, for example, may be housed in a nozzle 204 of the end effector 200. The external actuation source may comprise one or more motors capable of imparting sufficient kinetic energy to constituent within the end effector 200 from outside the continuous volume of the end effector 200 to transform the constituent from a solid state to a fluid-like state. The end effector 200 includes a material barrel 202, the nozzle 204, a suspension frame 216, an actuator 206, an actuator controller 208, and an agitation needle 210, and an agitation effector 214. The actuator 206 may include a first motor 218 and a second motor 220. The end effector 200 may generally extend longitudinally along an axis 20. The suspension frame 216 may be outside an internal volume of the material barrel 202 and house the actuator 206. The actuator controller 208 may be electrically coupled with the actuator 206 via one or more wires 212. The end effector 200 may be indirectly actuated with the actuator 206 to sufficiently stimulate constituent in solid form (e.g., powder, granules, etc.) to cause it to transform from the solid state to a pseudo-fluid like state for application with the end effector 200.

The actuator controller 208 may be used to vary one or more of an amplitude or frequency of the actuator 206. The actuator controller 208 may have, for example, a knob 250 that may increase one or more of the amplitude or frequency of actuation. The actuator 206 may be, for example, one or more vibratory motors that may include, for example, an electric motor with an eccentric or unbalanced mass on a drive shaft capable of producing sufficient eccentric motion to generate vibrations that transform constituent within the material barrel 202 from a solid state to a pseudo fluid state. However, it is contemplated that the actuator 206 may be any type of actuator capable of imparting sufficient energy to transform the constituent. For example, the actuator 206 may include one or more ultrasonic transducers. The required amplitude and frequency of actuation may vary based on one or more factors, such as the chemical or material properties of the constituent or parameters of the intended construct. In other embodiments of the system, the frequency and/or amplitude may be controlled by software control, for example. In some embodiments, the end effector 200 may be battery powered such that embodiments may not include the wires 212. The actuator 206 may be outside the material barrel 202. Hence, the actuator 206 may not be in direct contact with the constituent as it flows through the material barrel 202 as described in greater detail herein.

In operation, the end effector 200 may be coupled to a 3D printer tool body or similar device, such as the mount 112 depicted in FIG. 4. The actuator 206 may receive an actuation signal from the actuator controller 208 causing it to actuate. For example, in embodiments in which the actuator 206 includes one or more vibratory motors, the vibratory motors may begin to vibrate at sufficient speed to cause constituent within the material barrel 202 to transform from a solid or static state to a pseudo fluid state. Gravity may cause the constituent in the pseudo fluid state to pass through the material barrel 202 through the nozzle 204 and out of the nozzle 204. In embodiments including an agitation needle 210, the pseudo fluid constituent may flow along the agitation needle until it is deposited on a 3D-printed construct.

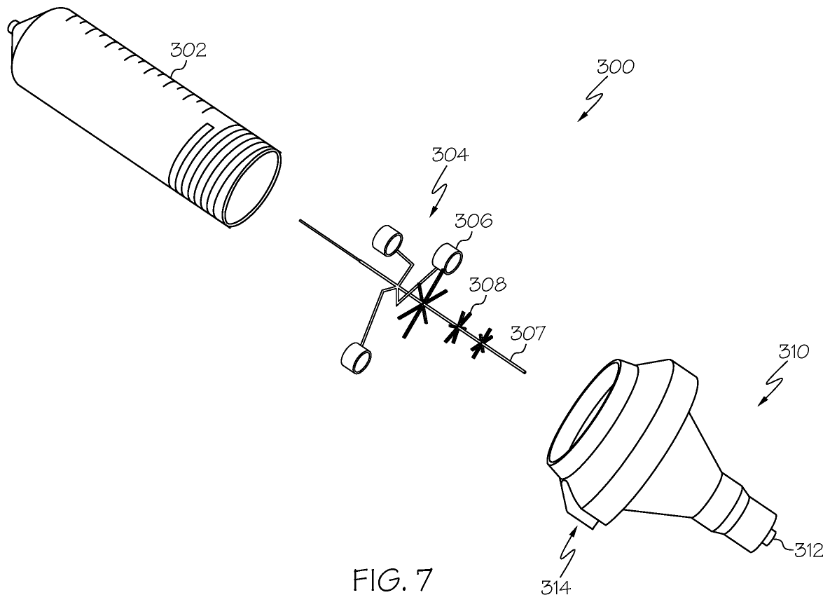

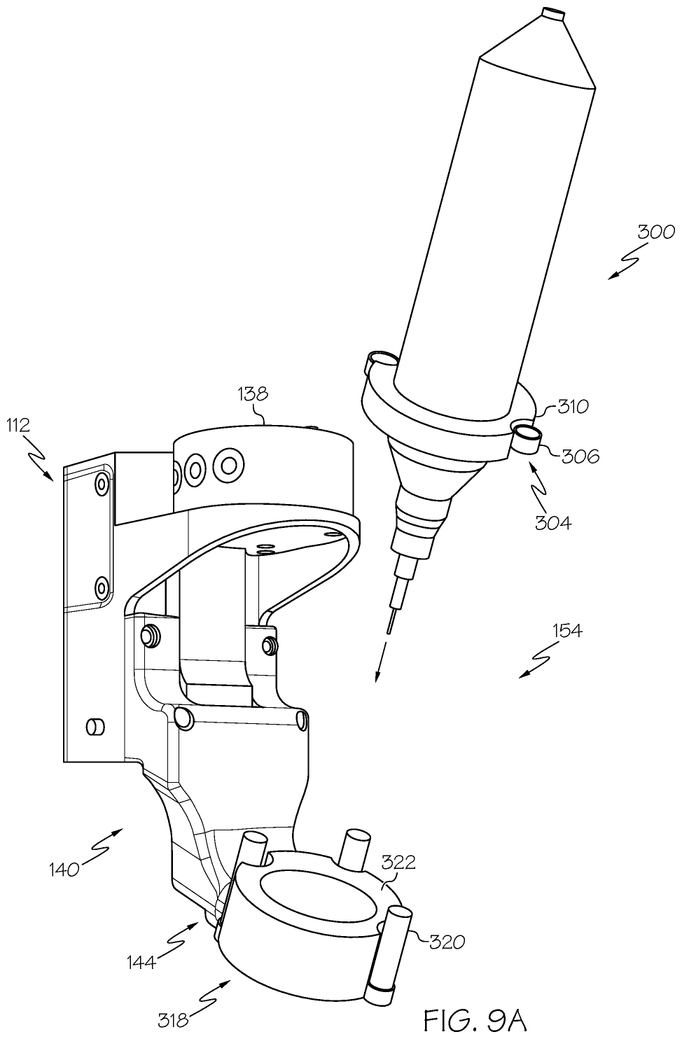

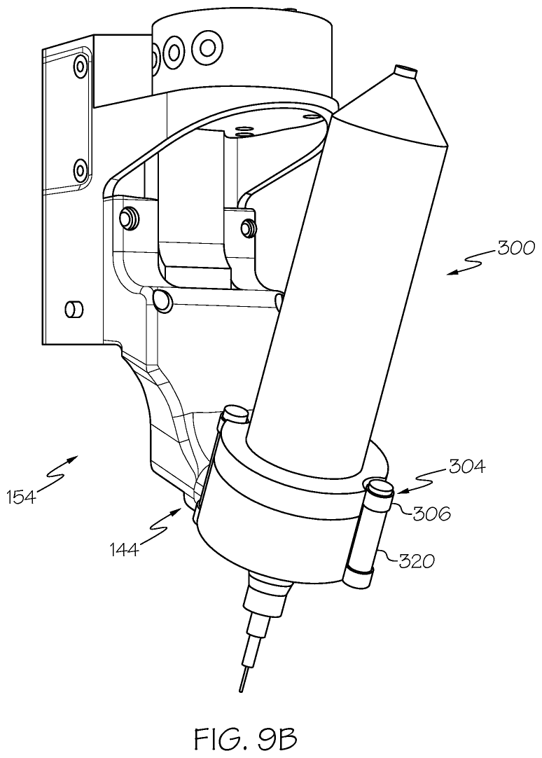

FIG. 7 depicts an exploded view of a particular embodiment of an end effector 300 that is configured to dispense constituent based on actuation of an externally-disposed actuator as will be described in greater detail. FIG. 7 further shows a material barrel 302, an agitation assembly 304 including actuator mounts 306, an agitation needle 307, and agitation effectors 308, a funnel housing 310, and a dispense tip 312. The funnel housing 310 may include mount locations 314 that provide a location for the actuator mounts 306 that is external to the continuous volume formed by the material barrel 302 and the funnel housing 310. Briefly referring to FIGS. 9A and 9B, the end effector 300 may be configured to mount to the tool mount portion 140 of the mount 112 of a 3D printer toolbody 154 at an external actuation mount assembly 318 as described in greater detail herein.

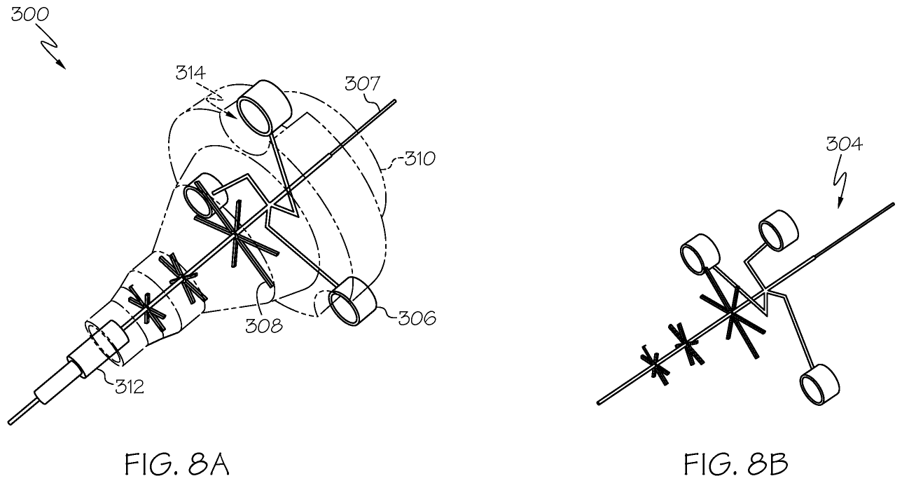

FIGS. 8A and 8B show a portion of the end effector 300 and agitation assembly 304 in greater detail. As shown in FIG. 8A, the agitation assembly 304 is configured to mount inside the funnel housing 310. The agitation assembly 304 may be, for example, press fit within the funnel housing 310. Generally, the internal surfaces of the funnel housing 310 direct the flow of constituent from the powder or static form in the material barrel 302 (FIG. 7) along the agitation needle 307 and out of the end effector 300. Some embodiments of the end effector 300 may include the dispense tip 312. The dispense tip 312 may be a removable tip that removably couples with the funnel housing 310 via a threaded connection or other interface. The dispense tip 312 may include a needle and an orifice and may be substantially similar to the dispense tip 111 of FIG. 1. Constituent may flow along the needle and out of the orifice to dispense constituent with the end effector 300.

As shown in FIGS. 8A and 8B, the actuator mounts 306 are external to the funnel housing 310. The actuator mounts 306 may fit within the mount locations 314 and may be coupled to the agitation needle 307 with a mount support 316. The mount locations 314 provide a location for the actuator mounts 306 in relation to the funnel housing 310. The mount supports 316 mechanically couple the actuators (not shown) and the agitation needle 307 such that the agitation needle 307 excites constituent in powder or static form to transform into pseudo-fluid like form for deposition with the end effector 300. The agitation effectors 308 may be fixably coupled to the agitation needle 307 and may contact the constituent during actuation to assist in the transformation of constituent from static to pseudo-fluid like state. It is to be understood that the particular embodiment shown in FIGS. 8A and 8B is not limiting with respect to the agitation effectors 308. Embodiments may include any number of agitation effectors with any shape or physical characteristics. The structural and material properties of the agitation effectors 308 may be tuned based on the particular constituent as described in greater detail herein.

FIGS. 9A and 9B show the end effector 300 coupled to the mount 112 at the external actuation mount assembly 318. The external actuation mount assembly 318 includes actuators 320 and an effector adaptor 322. The actuators 320 may be mounted to the effector adaptor 322. The actuators 320 may be, for example, one or more vibratory motors that may include, for example, an electric motor with an eccentric or unbalanced mass on a drive shaft capable of producing sufficient eccentric motion to generate vibrations that transform constituent within the material barrel 302 from a solid state to a pseudo fluid state. However, it is contemplated that the actuators 320 may be any type of actuator capable of imparting sufficient energy to transform the constituent. For example, the actuators 320 may include one or more ultrasonic transducers. The required amplitude and frequency of actuation may vary based on one or more factors, such as the chemical or material properties of the constituent or parameters of the intended construct.

The effector adaptor 322 may be configured to couple to the 3D printer toolbody 154 at the attachment interface 144 such that the 3D printer toolbody 154 can move the end effector 300 as described in greater detail herein. The effector adaptor 322 and the end effector 300 may be configured with one or more attachment mechanisms that may enable the effector adaptor 322 to receive the end effector 300 quickly and securely. For example, the effector adaptor 322 and the end effector 300 may include one or more magnets, fasteners, spring loaded quick releases, etc. The magnets, fasteners, etc. may hold the end effector 300 in the effector adaptor 322.

As shown in FIGS. 9A and 9B, the actuator mounts 306 of the agitation assembly 304 receive the actuators 320 such that the actuators 320 are mechanically coupled with the agitation assembly 304 (best shown in FIGS. 8A and 8B). Actuation of the actuators 320 (e.g., vibratory motion) causes the agitation needle 307 and agitation effectors 308 to actuate (e.g., vibrate). This actuation causes constituent in the material barrel 302 to pass through the funnel housing 310 and out the end effector 300 to be deposited, for example, on a 3D print stage to form a 3D-printed construct. While the depicted embodiment includes three actuators, it is to be understood that embodiments may include any number of actuators (e.g., one, two, four, etc.)

It should now be understood that embodiments disclosed herein are directed to an end effector for consistently dispensing constituent from a 3D printing tool to print a 3D construct. The end effector generally includes a material barrel for holding raw constituent, an actuator and frame assembly for holding an actuator that is capable of transforming the raw constituent into a depositable form suitable for dispensation by the end effector of the 3D printer. The end effector generally includes a nozzle and a wire that protrudes from the nozzle. In the depositable form, constituent travels along the wire and out the nozzle where it is deposited, thus forming the construct. Constituent may be deposited, for example, on the printing stage of the 3D printer, within vials or small vessels, or onto other bioprinted constructs. Constituents used in the end effectors described herein generally have a powder or granule form prior to actuation of the end effector and upon sufficient actuation (e.g., mechanical vibration), the powder or granules transform from a solid state to a pseudo fluid state in which the constituent is depositable. The physical position of the end effector with respect to the print stage may be controlled, for example, by a multi-axis robotic arm that may be moveable via instructions provided to a controller of the multi-axis robotic arm via a multi-purpose computer communicatively coupled to a user interface. Accordingly, 3D-printed constructs having various sizes and shapes may be formed using the end effector.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An end effector, comprising:
a continuous volume that holds a constituent and includes a nozzle;
a suspension frame disposed within the continuous volume;
an actuator; and
an agitation needle that protrudes from the continuous volume through the nozzle, wherein
the actuator is suspended by the suspension frame within the continuous volume such that the constituent within the continuous volume is in direct contact with one or more of the actuator and the agitation needle, and
the actuator is configured to actuate such that, upon actuation, the constituent transforms from a static state to a pseudo-fluid like state for application with the end effector.

2. The end effector of claim 1, wherein the actuator comprises at least one vibratory motor.

3. The end effector of claim 2, wherein the at least one vibratory motor oscillates between 1,000-16,000 RPM.

4. The end effector of claim 2, wherein the actuator comprises:
a first vibratory motor; and
a second vibratory motor, wherein
the first vibratory motor and the second vibratory motor are disposed about a first axis and coupled to the suspension frame at opposing ends of the suspension frame.

5. The end effector of claim 1, wherein the actuator comprises at least one ultrasonic transducer.

6. The end effector of claim 1 further comprising a measurement transducer configured to determine an amount of constituent within the continuous volume of the end effector.

7. The end effector of claim 1, wherein the continuous volume comprises a funnel housing including the nozzle and a material barrel configured to hold the constituent.

8. The end effector of claim 7, wherein the funnel housing comprises a wiring cavity and the suspension frame comprises a port and electrical power is supplied to the actuator via one or more wires run through the wiring cavity and the port.

9. The end effector of claim 1, wherein the continuous volume further comprises a material barrel and the material barrel is a 50 mL centrifuge vial.

10. The end effector of claim 1, wherein the agitation needle is interchangeable.

11. The end effector of claim 1, wherein the agitation needle comprises an agitation effector.

12. An end effector, comprising:
a continuous volume that holds a constituent and includes a nozzle;
a suspension frame disposed outside the continuous volume;
an actuator; and
an agitation needle that protrudes from the continuous volume through the nozzle, wherein
the actuator is suspended by the suspension frame outside the continuous volume and coupled to the agitation needle, and
the actuator is configured to actuate such that, upon actuation, the constituent transforms from a static state to a pseudo-fluid like state for application with the end effector.

13. The end effector of claim 12, wherein the actuator comprises at least one vibratory motor.

14. The end effector of claim 13, wherein the at least one vibratory motor oscillates between 1,000-16,000 RPM.

15. The end effector of claim 12, wherein the actuator comprises at least one ultrasonic transducer.

16. The end effector of claim 12 further comprising a measurement transducer configured to determine an amount of constituent within the continuous volume of the end effector.

17. The end effector of claim 12, further comprising an attachment interface that is configured to removably attach to a 3D printer toolbody.

18. A 3D printer toolbody comprising:
a mount comprising:
an arm mount portion; and
a tool mount portion;
an end effector comprising:
a continuous volume including a nozzle and configured to hold a constituent;
a suspension frame disposed within the continuous volume;
an actuator; and
an agitation needle that protrudes from the continuous volume through the nozzle, wherein
the actuator is suspended by the suspension frame within the continuous volume such that the constituent within the continuous volume is in direct contact with one or more of the actuator and the agitation needle, and
the actuator is configured to actuate such that, upon actuation, the constituent transforms from a static state to a pseudo-fluid like state for application with the end effector,
the end effector is coupled to the tool mount portion of the mount and the arm mount portion is coupled to a robotic arm of a 3D printer configured to move the 3D printer toolbody to form a 3D printed construct.

19. The 3D printer toolbody of claim 18, wherein the actuator comprises at least one vibratory motor.

20. The 3D printer toolbody of claim 19, wherein the actuator comprises:
a first vibratory motor; and
a second vibratory motor, wherein
the first vibratory motor and the second vibratory motor are disposed about a first axis and coupled to the suspension frame at opposing ends of the suspension frame.
